(19) United States
(12) Patent Application Publication
(10) Pub. No.: US 2009/0206524 A1
(43) Pub. Date: Aug. 20, 2009

(54) Moulding Apparatus and Method

(76) Inventors: Keith Laidler, West Midlands (GB); Martin James, Berks (GB)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 11/989,126

(22) PCT Filed: Jul. 24, 2006
(86) PCT No.: PCT/GB2006/002751

§ 371 Date: Apr. 20, 2009

(30) Foreign Application Priority Data
Jul. 22, 2005 (GB) 0515054.5
Jan. 17, 2006 (GB) 0600944.3
Mar. 15, 2006 (GB) 0605143.7

(51) Int. Cl. B29C 49/00; B32B 1/08; B32B 1/00

(52) U.S. Cl. 264/516; 428/34.1; 425/541

(57) ABSTRACT

Moulding apparatus comprises a mould (12) defining a blow mould cavity (14) and a core (18) which projects into the blow mould cavity. The mould has at least one mould member (22, 24, 26) movable to an extended position in which it defines together with the core (18) at least part of a preform moulding cavity (28) for moulding a preform. The at least one mould member (22, 24, 26) can be moved to a retracted position [FIG. 2] whereby a preform produced in the preform moulding cavity can be expanded into the blow mould cavity. The moulding apparatus includes a locking member (22) adapted to engage the core so as to resist lateral movement of the core whilst material is introduced into the preform moulding cavity. A method of using the apparatus is also disclosed and claimed.

The present invention relates to an apparatus and method for moulding an article. The present invention also relates to containers and other articles which can be manufactured using such an apparatus and method and to their preforms.

It is known to produce articles from thermoplastic materials by means moulding. In known injection moulding techniques a space or cavity is created between a male mould tool and a female mould tool and the plastic material is injected into the cavity under pressure. The male tool is then removed and the female tool, which comprises two or more parts, is split so that the article can be ejected. However, this process is not suitable for moulding hollow articles with narrow necks, such as bottles, because the male tool which defines the inner shape of the bottle could not be removed from the moulded article. Articles of this nature are often produced by blow moulding in which a preform or parison, usually in the form of an injection moulded or extruded tube with a closed end, is placed inside a female mould tool. Air, which may be hot, is then blown inside the preform under pressure to act as the male tool and expand the preform into a cavity within the female mould tool which defines the required shape of the article. The female tool can then be split to release the article. Part of the preform may be held between close fitting surfaces of the female tool so that it doesn't expand, to form a neck or other opening for the article.

The term blow moulding is used to describe this type of moulding because a gas, usually air, is “blown” into the preform to cause it to expand. However, other arrangements for causing the preform to expand can be adopted. For example, gases other than air and even a liquid could be injected into the preform to cause it to expand. Alternatively, or in addition, a vacuum could be created on the outside of the preform to draw the preform into the mould cavity. For convenience, the term “blow moulding” will be used throughout this specification, including the claims, but it should be understood that this term is intended to cover any method or apparatus for moulding in which a preform is caused to expend as a result of a pressure differential, except where the context requires otherwise.

There are two main processes used in blow moulding. One process, which is sometime referred to as a single-stage process, involves producing a preform by injection moulding or extrusion at a first station on a machine and then transferring the preform to another station on the same machine where the blow moulding operation is carried out. In the other known process, referred to as a two-stage process, the preform is produced on one machine and the blow moulding process is carried out on a separate machine. Where a two-stage process is used, preforms can be produced at an entirely different location from the blow moulding process and may be stored for later processing. Indeed use of the two-stage process has led to the creation of a separate industry in the manufacture and supply of preforms for blow moulding.

These known methods of blow moulding have significant drawbacks. Even where a so called single-stage process is used, the machines are very large and expensive and there is a considerable cycle time involved in transferring the preform from the injection moulding or extrusion station to the blow moulding station, often through one or more conditioning stations. The known processes are also very limited in being capable of producing only standard bottle and the like containers with separate closure members.

In a further known process for blow moulding, an elongate tube of plastics material is passed through a tool where it is reheated and a bottom end is sealed prior to being blown. This process is cheap and has relatively fast cycle times but is only suitable for producing basic vessels. The process also uses two different machines and two heating/cooling operations and is wasteful of plastic.

An injection blow-moulding system which attempts to overcome the drawbacks of the known processes is disclosed in WO 2004/026560 to ALPHA-WERKE ALWIN LEHNER GMBH & CO.KG. This system comprises a number of central cores which operate as blow mandrels. A pair of clamping jaws surrounds each core and the jaws co-operate with a first female mould member to define an injection moulding cavity about the core into which material is injected to produce a preform. Once the preform has been moulded, the first female mould member is replaced with a second female mould member which co-operates with the jaws to define a blow moulding cavity. Air is then blown through the core to expand part of the preform to form the hollow article.

The system disclosed in WO 2004/026560 overcomes some of the drawbacks of the known single-stage blow moulding process but the arrangements for replacing the female injection mould tool with the female blow mould tool are complex and the process time taken to make the changeover is still significant in an industry which is very cost sensitive.

There is a need, therefore, for a moulding apparatus and method which overcomes, or at least reduces, some of the disadvantages of the known blow moulding apparatus and processes.

It is an objective of the present invention to provide a moulding apparatus and method that reduces the cycle time required to produce a preform and blow mould an article from the preform.

It is a further objective of the invention to provide a moulding apparatus and method capable of producing a preform and blow moulded article.

It is a further objective of the invention to provide a moulding apparatus and method capable of producing a hollow container in which an inner volume is dived into two or more separate chambers.

In accordance with a first aspect of the invention there is provided moulding apparatus in accordance with claim 1. Further features of the first aspect of the invention are set out in the claims dependent on claim 1.

In accordance with a second aspect of the invention there is provided a method of moulding an article in accordance with claim 42. Further features of the second aspect of the invention are set out in the claims dependent on claim 42.

In accordance with a third aspect of the invention there is provided moulding apparatus in accordance with claim 63. Further features of the third aspect of the invention are set out in the claims dependent on claim 63.

In accordance with a fourth aspect of the invention there is provided a method of moulding an article in accordance with claim 79. Further features of the fourth aspect of the invention are set out in the claims dependent on claim 79.

In accordance with a fifth aspect of the invention, there is provided a blow moulded container in accordance with claim 93. Further features of the fifth aspect of the invention are set out in the claims dependent on claim 93.

In accordance with a sixth aspect of the invention, there is provided a preform for a blow moulded container in accordance with the fifth aspect of the invention as defined in claim 94. Further features of the sixth aspect of the invention are set out in the claims dependent on claim 94.

In accordance with a seventh aspect of the invention, there is provided a blow moulded container in accordance with claim 95. Further features of the seventh aspect of the invention are set out in the claims dependent on claim 95.

In accordance with an eighth aspect of the invention, there is provided a preform for a blow moulded container in accordance with the seventh aspect of the invention as defined in claim 97. Further features of the seventh aspect of the invention are set out in the claims dependent on claim 97.

In accordance with a ninth aspect of the invention, there is provided a blow moulded container in accordance with claim 99. Further features of the ninth aspect of the invention are set out in the claims dependent on claim 99.

In accordance with a tenth aspect of the invention, there is provided a preform for a blow moulded container in accordance with the ninth aspect of the invention as defined in claim 102. Further features of the tenth aspect of the invention are set out in the claims dependent on claim 102.

In accordance with an eleventh aspect of the invention, there is provided a blow moulded container in accordance with claim 103. Further features of the ninth aspect of the invention are set out in the claims dependent on claim 103.

In accordance with a twelfth aspect of the invention, there is provided a preform for a blow moulded container in accordance with the eleventh aspect of the invention as defined in claim 104. Further features of the tenth aspect of the invention are set out in the claims dependent on claim 104.

Several embodiments of the invention will now be described, by way of example only, with reference to the accompanying drawings in which:

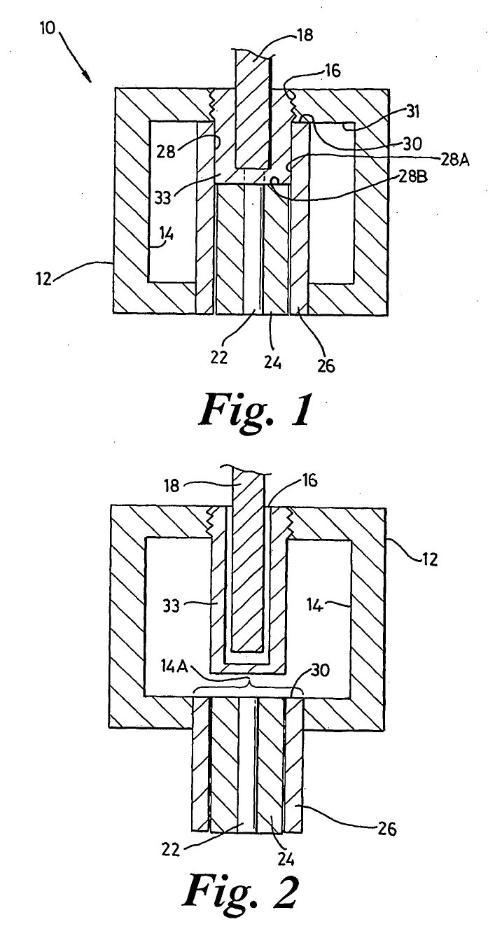

FIG. 1 is a cross sectional view through part of a first embodiment of a moulding apparatus in accordance with the invention, showing the apparatus in a condition in which a preform has been injection moulded;

FIG. 2 is view similar to that of FIG. 1 but showing the apparatus in a condition in which the preform is being stretched prior to blow moulding;

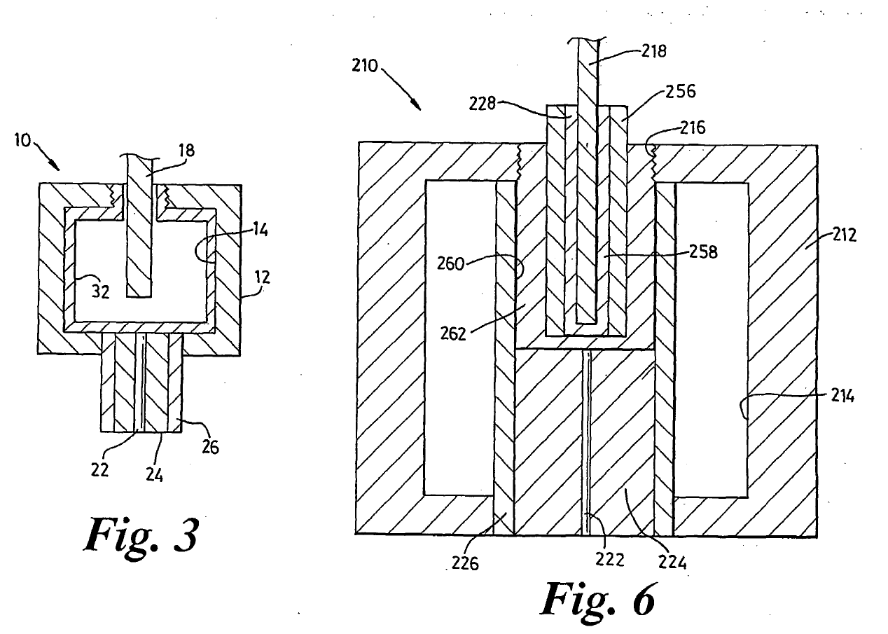

FIG. 3 is a view similar to that of FIGS. 1 and 2 but showing the apparatus in a condition in which the preform has been expanded;

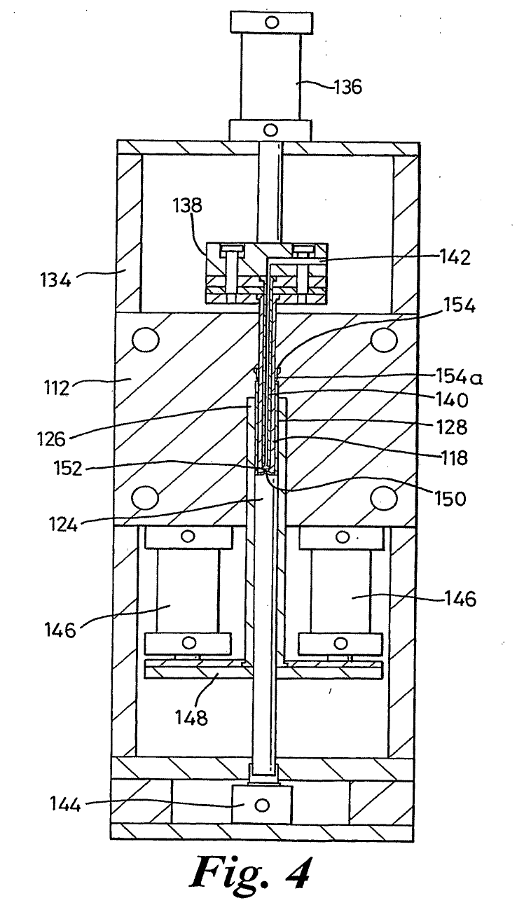

FIG. 4, is cross sectional view through a second embodiment of a moulding apparatus in accordance with the invention, showing the apparatus configured to provide an injection moulding cavity for a preform;

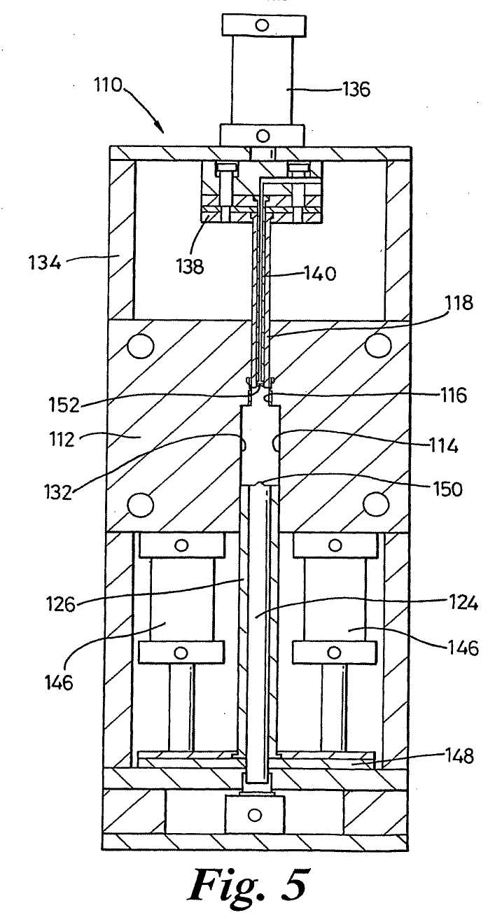

FIG. 5 is a view similar to that of FIG. 4, but showing the apparatus of the second embodiment re-configured to provide a blow moulding cavity for the preform;

FIG. 6 is a view similar to that of FIG. 1 but of a third embodiment of a moulding apparatus in accordance with the invention for producing a laminated article, showing the apparatus in a condition in which an injection moulding cavity for a second layer of material has been formed;

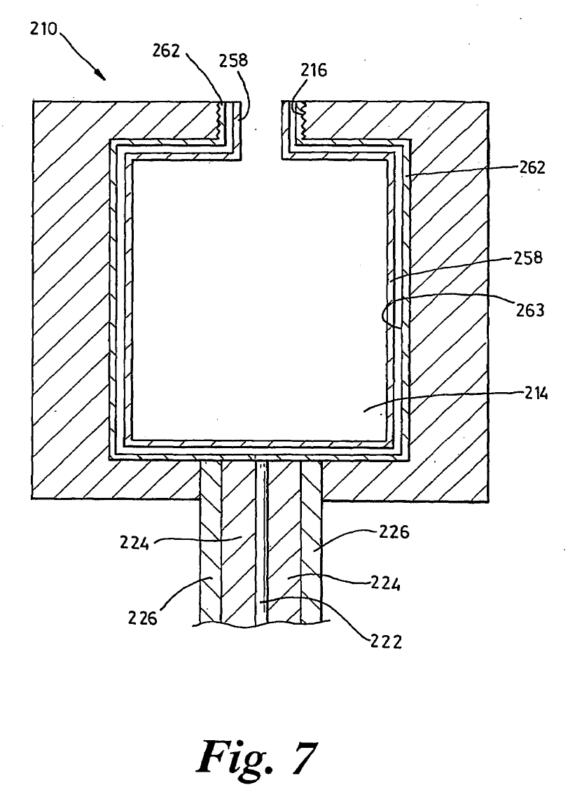

FIG. 7 shows the apparatus of FIG. 6 after the preform has been blow moulded to form a container;

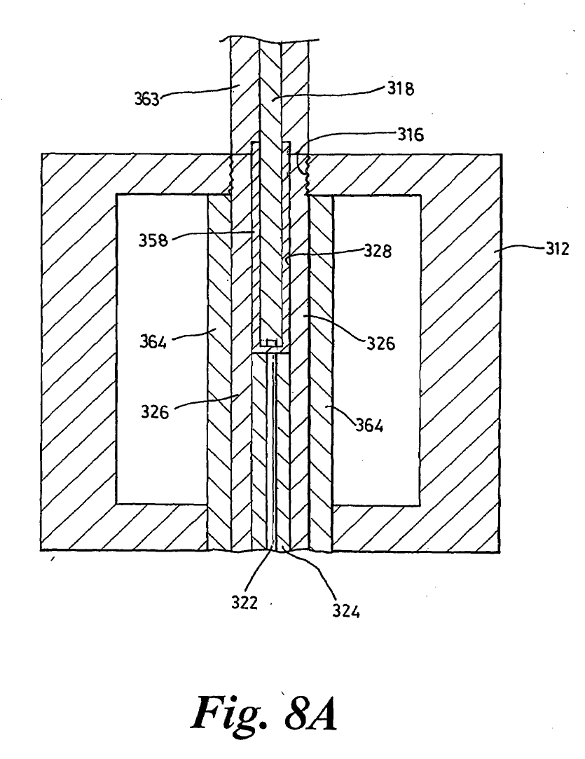

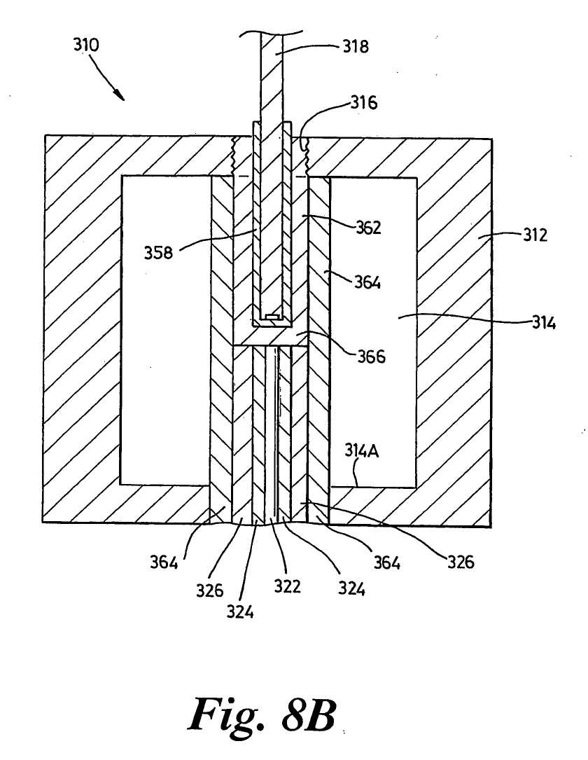

FIGS. 8A and 8B are views similar to that of FIG. 6 but showing an alternative embodiment of a moulding apparatus adapted to produce a laminated article;

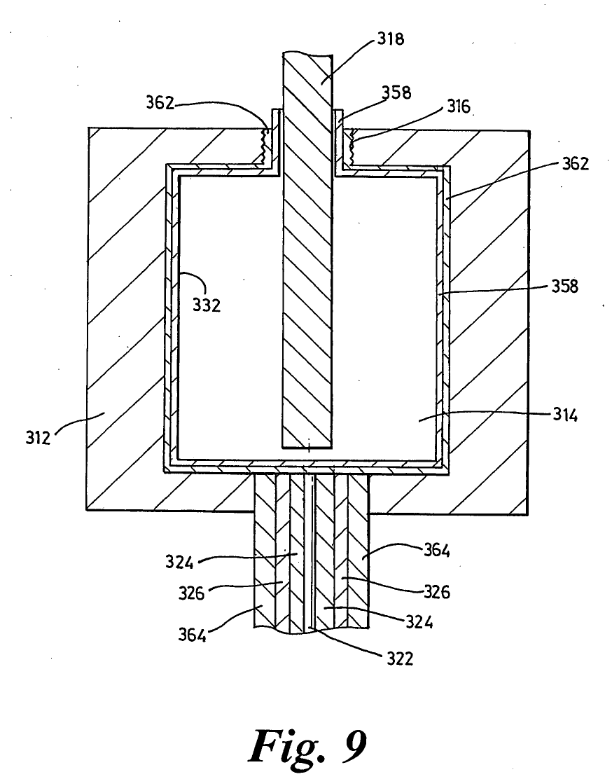

FIG. 9 shows the embodiment of FIGS. 8A and 8B after the preform has been blown moulded to form a container;

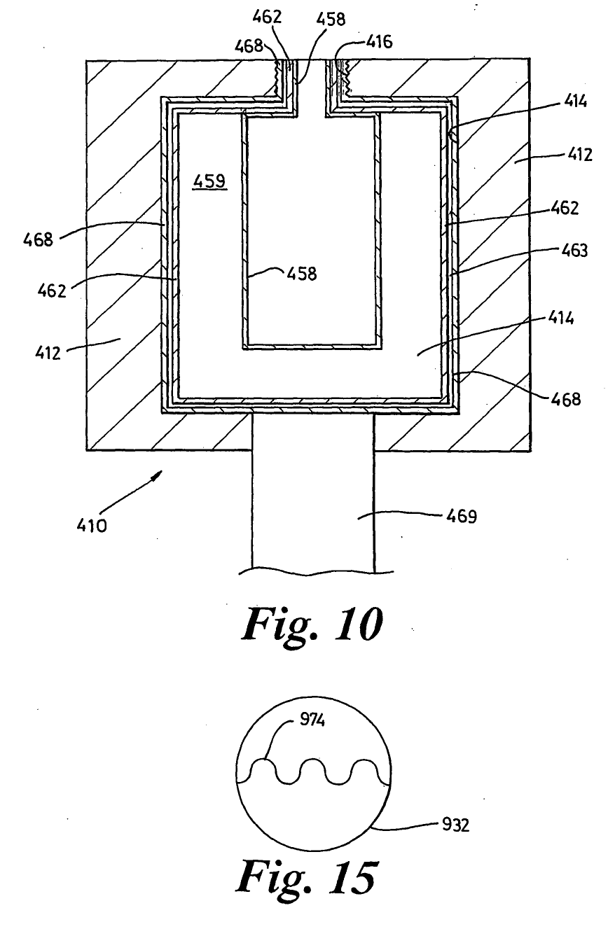

FIG. 10 is a view similar to that of FIG. 9 but showing a further embodiment of the invention in which the apparatus is configured to produce a container having three layers of material, the inner layer being only partially expanded;

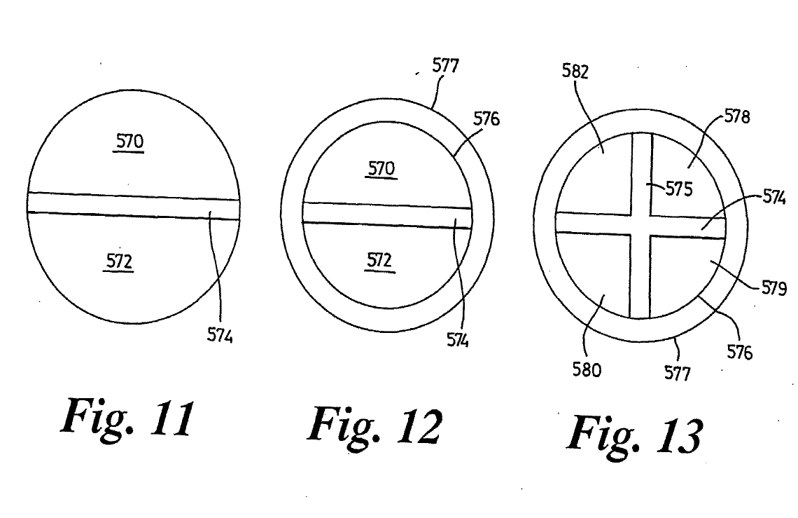

FIGS. 11 to 13 are schematic cross sectional views through a number of different configurations of containers that can be produced using the apparatus and method of the invention;

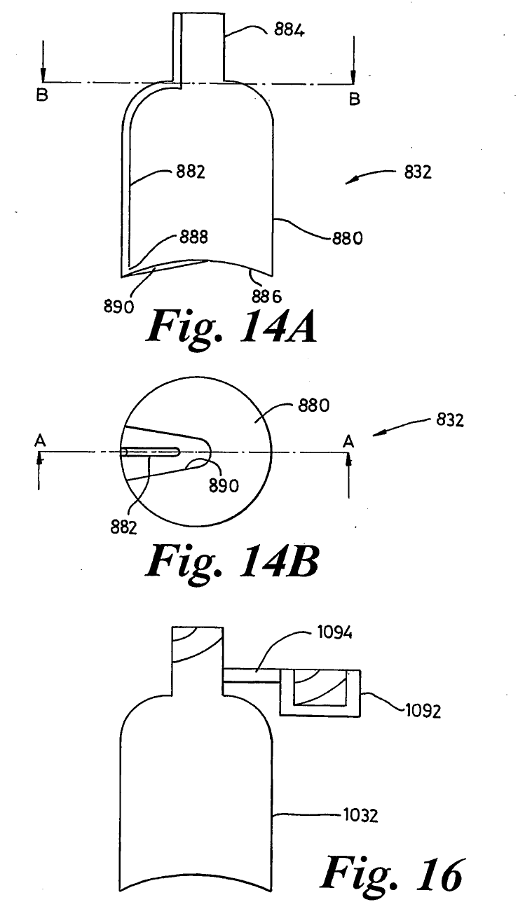

FIG. 14A is a schematic cross sectional view taken on line A-A in FIG. 14B of a further configuration of a container that can be produced using the apparatus and method of the invention incorporating and integral dip tube;

FIG. 14B is a schematic cross sectional view taken on line B-B in FIG. 14A;

FIG. 15 is a schematic cross sectional view through a further configuration of a container that can be produced using the apparatus and method of the invention having a shaped dividing wall;

FIG. 16 is a schematic side elevation of a further configuration of a container that can be produced using the apparatus and method of the invention incorporating an integral lid; and

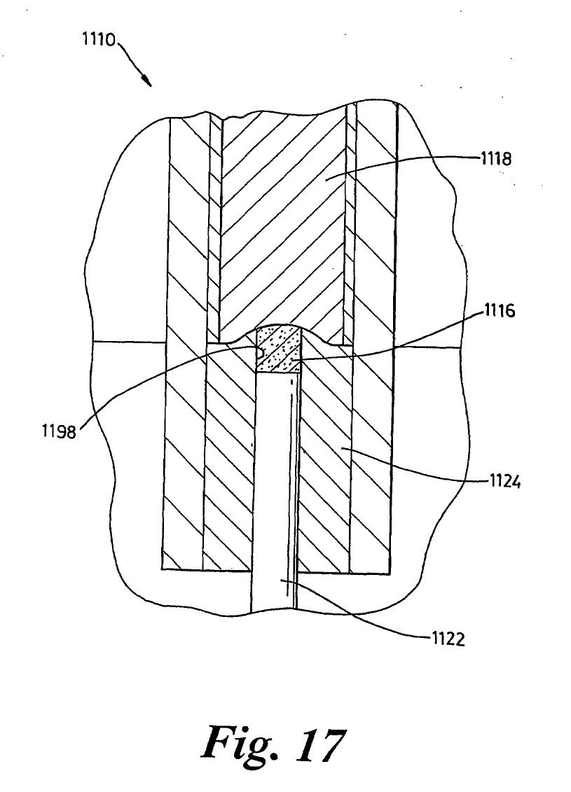

FIG. 17 is a partial view of the base region of the apparatus of FIG. 1 showing a modified form of the apparatus.

With reference initially to FIGS. 1 to 3, there is disclosed a first embodiment of a moulding apparatus 10 in accordance with the invention. The apparatus 10 comprises a female mould tool 12 which defines a blow moulding cavity 14 into which a preform can be expanded to form an article. The female mould tool 12 is a split tool comprising a number of parts which can be separated to enable the article to be ejected after it has been blow moulded.

In the present embodiment, the article to be produced is a hollow container, such as a bottle or the like, but the apparatus and method of the invention can be used to produce a wide variety of articles. The articles produced by the apparatus and method of the invention may be fully finished articles or they may be subjected to further manufacturing processes.

When closed, as shown in FIGS. 1-3, the female mould tool 12 defines an opening 16 which is the same diameter as a neck region of the container and which can incorporate a screw thread or other feature to be produced on the neck of the container. A core 18 is extendable into the blow moulding cavity 14 through the opening 16, as shown in FIGS. 1 to 3.

Preferably, the core 18 is able to move relative the female mould tool 12 so that it can be retracted from the blow moulding cavity and to enable the preform to be stretched either during or prior to being blow moulded. It will be appreciated that relative movement between the core 18 and the female mould tool 12 can be effected by moving the core 18 relative to the mould tool 12, the mould tool 12 relative to the core 18, or through a combination of the two. The core 18 is supported at a first, proximal end which is located externally of the blow mould cavity and a second, distal end 18A of the core is inserted through the opening 16 into the blow moulding cavity 14.

Forming part of a base region 14A of the female mould tool 12 opposite the opening 16 are three movable mould members: a central locking pin 22, a first tube member 24 surrounding the central locking pin 22, and a second tube member 26 which surrounds the first tube member 24. The movable mould members 22, 24, 26 can all be moved to a position in which they extend into the blow mould cavity so as to define a preform injection moulding cavity 28 in co-operation with the core, as shown in FIG. 1. In these extended positions, the second tube member 26 completely surrounds the core 18 with its end face 30 abutting the inner surface 31 of the mould cavity adjacent the opening 16 to form the outer surface of a side wall region 28A of the injection moulding cavity 28. The central locking pin 22 and the first tube member 24 are spaced from the distal end of the core 18 to form a base region 28B of the injection moulding cavity 28. Thus the extended movable mould members 22, 24, 26 in co-operation with the core 18 define an injection moulding cavity 28 adapted to produce a preform in the shape of a tube with a closed end.

Whilst the drawings show the base region 28B of the injection moulding cavity as being flat with sharp corners between the base region 28B and the side wall region 28A, it will be appreciated that this is only a schematic representation and that the base region 28B will usually have a part spherical shape so that there are no sharp corners which may result in the container rupturing when it is blown.

From the positions shown in FIG. 1, the movable mould members 22, 24, 26 can be retracted to the positions shown in FIGS. 2 and 3 in which they define part of the base region 14A of the blow moulding cavity 14. Although the base region 14A is shown as being flat in FIGS. 2 and 3 with the ends of the movable mould members 22, 24, 26 in alignment, this need not be the case. The profile of the base region 14A may be varied and the movable mould members 22, 24, 26 can be positioned at different levels when retracted to define features on the base of the container to be blow moulded. If necessary, the number of movable mould members 22, 24, 26 can be increased in order that a desired pattern or feature can be produced within the base region 14A. Alternatively, a base plate may be provided which can be moved into position over the base of the mould tool 12 once the moveable mould members have been retracted. The base plate would be provided with a shaped upper surface to define the contours of the base of the container. The base plate or the movable mould members may be configured to produce a hole or holes in the base.

Operation of the moulding apparatus 10 of FIGS. 1 to 3 will now be described.

With the apparatus as shown in FIG. 1, the female mould member 12′ is closed to define a blow moulding cavity 14. The core 18 is projected part way into the blow moulding cavity 14 and the movable mould members 22, 24, 26 are also extended into the blow mould cavity to define with the core 18 the preform injection moulding cavity 28 as described above. In this configuration, plastics material can be injected or extruded into the preform moulding cavity 28 between the core 18 and the movable mould members to produce a tubular preform 33.

One of the problems encountered in injection or extrusion moulding a long tube 33 is the tendency for the core to move to one side under the moulding pressures, which causes the resulting tube 33 to be of uneven thickness. To overcome this problem, the central locking pin 22 will initially be extended until it engages with a hole in the distal end of the core 18 to hold it in position, as indicated by the dotted lines in FIG. 1. The plastics material is injected into the injection moulding cavity 28 around the sides and base as normal. As the injection moulding process nears its conclusion, the central locking pin 22 is retracted to the position shown in FIG. 1 so that the hole it occupied can be filled with material. Use of the central locking pin 22 holds the core in position resisting lateral movement of the core. This helps to ensure the preform has an even thickness and makes it possible to produce a thinner walled tubular preform 33 than might otherwise be possible. Other means of holding the core 18 in position against lateral movement could be used. For example, more than one locking pin can be provided and locking pins could be arranged to extend from the sides of the blow moulding cavity 14 through openings in the second tube member 26. In certain applications the central locking pin 22 can be omitted, in which case the first tube member 24 and the central locking pin 22 can be replaced with a solid pin.

In some cases it may be desirable to produce a shaped bottle or other vessel in which the thickness of the side wall varies so that some parts are thicker than others. When moulding a preform with thicker side wall regions, this can result in the inner core 18 moving in the preform mould cavity 28 making it difficult to control the moulding process. In these circumstances, the ability to lock or hold the core 18 in position within the preform moulding cavity 28 during the majority of the injection moulding phase is also highly advantageous.

Whilst the plastic 33 in the injection moulding cavity 28 is still hot but stable enough to maintain its form, or thereabouts, the movable mould members 22, 24, 26 are withdrawn to their retracted positions as shown in FIGS. 2 and 3, thus exposing the blow moulding cavity 14 into which the preform 33 can be expanded by injecting air into the inside of the preform. However, in the present embodiment, the preform 33 is also stretched by the core 18 in accordance with the known technique of stretch blow moulding. Thus, as shown in FIG. 2, after the movable mould members 22, 24, 26 have been withdrawn, or whilst they are still in the process of being withdrawn, the core 18 is slowly advanced further into the blow mould cavity 14 to stretch the preform 33. Air is then injected into the inside of the preform 33 to expand it into the blow moulding cavity. The air may be heated and can be introduced either whilst the preform is being stretched or afterwards or both. The preform 33 is fully expanded into the blow moulding cavity 14 to form a container 32, as shown in FIG. 3. The region of the preform contained in the opening 16 of the female mould tool 10 is not expanded but forms the neck of the container in a known manner. It will be appreciated that the step of stretching the preform 33 could be omitted if desired.

When stretching the preform, the core 18 may initially be retracted slightly and pressurised air introduced inside the preform through the core to partially expand the preform as the core is subsequently advanced. Once the preform has been stretched by the required amount, the pressure of the air is increased to expand the preform into the blow mould cavity. The core 18, may initially be retracted most of the way out of the preform to allow the preform to cool evenly before it is stretched. The cooling process may be accelerated by injecting cold fluid, such as air or another gas, into the blow mould chamber and/or through the core pin 18 inside the preform.

In order to remove the blow moulded container 32, the core 18 is withdrawn from the blow mould cavity 14 and the female mould tool 12 is split to enable the container 32 to be ejected. The female mould tool 12 can then be reformed so that the process can be repeated.

In the present embodiment, the core 18 also acts as a blow mandrel and has one or more air passages (not shown) through which air is introduced into the preform. With this arrangement, it is necessary to prevent the air escaping from between the open end of the preform 33 and the core 18. This could be achieved, for example, by providing a seal member (not shown) that engages with the open end of the preform 33 around the core 18. In an alternative arrangement, the core 18 can be withdrawn from the preform 33 and air injected into the preform through its open end using any suitable injector or nozzle arrangement. Each air passage in the core 18 may have one or more outlets through which the air is injected into the preform. To prevent plastics or other material from entering the air passages when the preform is being moulded about the core, each outlet comprises a one way valve that permits the air to exit the passage through the outlet but which prevents the plastics or other material from entering the passage.

In a further refinement, the first tube member 24 could be divided into two separate tube members, the outer one of which has an inner diameter slightly smaller than the inner diameter of second tube member 26. With this arrangement, the preform is injection moulded between the second tube member 26 and the core 18 as described above with the first tube member 24 and the locking pin 22 forming the base. After the second tube member 24 has been withdrawn, the outer part of the first tube member can then be raised so that it passes over outer surface of the tubular preform to force the material to become even in thickness. This can be done at the same time as the preform 33 is being stretched by the core 18.

The apparatus 10 provides a moulding system in which a preform injection moulding cavity 28 is created inside a larger blow moulding cavity 14. Thus, once the movable mould members 22, 24, 26 that form part of the injection moulding cavity are withdrawn, the preform can be blow moulded without the need to transfer the preform to another mould cavity. This enables the cycle times required to produce a preform and blow mould an article from the preform to be significantly reduced when compared with the prior art. Furthermore, because the preform remains within the blow moulding cavity at all times, its temperature and other characteristics can be closely controlled to provide suitable conditions for blow moulding. Conditioning of the preform prior to blow moulding can be carried out either before the movable mould members are retracted or afterwards. As discussed in more detail below, cold gas and/or liquid can be used to cool the moulding cavity and/or the core and movable mould members to even out the temperature of the preform prior to blowing.

It is a further advantage of the present embodiment of the invention that the movable members 22, 24, 26 are all simple tubes or pins that move linearly between their extended and withdrawn positions. This arrangement means that the required tooling can be produced at relatively low cost, though it should be understood that other arrangements for the moving parts of the mould could be adopted within the scope of the invention.

FIGS. 4 and 5 illustrate a tooling arrangement incorporating a second embodiment of an apparatus 110 in accordance with the invention. The tooling comprises a framework 134 to which is mounted a female mould tool 112 defining a blow moulding cavity 114 for a hollow container or bottle 132. A core 118 is mounted to a first pneumatic or hydraulic ram 136 via a mounting plate arrangement 138, so that the core can be introduced into, or withdrawn from, the blow, mould cavity 114 though an opening 116 in the mould tool 112 which defines a neck region of the container. An air passage 140 is formed through the centre of the core 118 and is fluidly connected with an air inlet 142 in the mounting plate arrangement 138.

A first movable mould member in the form of a central base pin 124 is mounted to a further pneumatic or hydraulic ram 144 so as to be movable into the blow moulding cavity. A second movable mould member in the form of a tube 126 surrounding the base pin 124 is mounted to a pair of pneumatic or hydraulic rams 146 via base plate member 148.

In the present embodiment, the central locking pin of the previous embodiment is omitted. Instead, the base pin 124 has a conical point 150 formed on its free end that engages in a correspondingly shaped indentation 152 in the free end of the core 118 to hold the core steady during the initial stages of injection moulding.

FIG. 4 shows the tooling in a condition ready for injection moulding of the preform. The first ram 136 has been extended to move the core 118 into the blow moulding cavity and the second ram 144 has also been extended to bring the conical point 150 on the base pin 124 into engagement with the indentation 152 on the end of the core 118, to hold the core steady. The second movable mould member or tube 126 has been advanced into the blow mould cavity 114 by retracting the pair of rams 146 so that the tube 126 surrounds the core 118. An injection moulding cavity 128 is thereby defined between the core 118, and the base pin 124 and tube 126. Material is injected into the cavity 128 though inlet 154 to form the preform. As the injection moulding process reaches its conclusion, the second ram 14 is retracted slightly to move the base pin 124 away from the end of the core 118 to allow material to form a base region of the preform.

Once the preform is sufficiently stable, the movable mould members 124, 126 are withdrawn to expose the preform to the larger blow moulding cavity 114. In the present embodiment, the base pin 124 stays in the same position it occupied at the end of the injection moulding process and only the second movable mould member or tube 126 is withdrawn by extending the rams 146, as shown in FIG. 5. This brings the free axial end of the tube 126 into line with the free end of the base pin 124 to define a base region of the blow mould cavity 114. Air is then introduced into the tubular preform through the air inlet 142 and the air passage 140 in the core 118 to expand the preform into the blow moulding cavity to form the container 132. Once the blow moulding operation is complete, the core 118 is withdrawn from the blow moulding cavity 114 and the container 132 by retracting the first ram 136 as shown in FIG. 5. The mould 112 can now be split to enable the container 132 to be ejected.

In an alternative arrangement, the base pin 124 may be stationary and the core 118 advanced to bring them into engagement in the early stages of injection moulding of the preform. The core 118 being lifted off the base pin 124 as the injection moulding phase nears completion so that the base of the preform can be produced.

Whilst hydraulic or pneumatic rams will usually be used to move the core 118 and the other movable mould members 124, 126, any suitable means for moving the various parts of the apparatus can be used in any of the embodiments described herein. For example, the core 118 and/or the movable mould members 124, 126 can be moved using electric stepper motors. This may be advantageous because of the precision of movement that can be obtained using stepper motors, which can controlled to within 200^{th} of an inch.

Conventionally when moulding a preform for a bottles and the like, the injection moulding cavity is fed via an injection cavity in the centre of the base region of the mould cavity. In the apparatus of the invention, this is not possible and so the material is feed into the preform mould cavity via a ring gate 154 which is located above the neck region of the mould cavity, though the ring gate 154 could be positioned elsewhere along the length of the mould cavity. The ring gate comprises a circular recess which is equidistant from the mould cavity and is fed from one or more injection gates. The ring gate is filled before the mould cavity and two or more feed channels 154a direct the material into the mould cavity. Preferably, the ring gate is positioned above the mould cavity so that the material flows evenly through the feed channels into the mould cavity.

The apparatus and method of the present invention can be used to blow mould articles from any suitable materials including, but not limited to, thermoplastics materials such as polyethylene, polyethylene terephthalate (PET), polyacrylonitrile (PAN), polyvinyl chloride (PVC), and polypropylene.

Whilst it is preferred that air is introduced into the preform to expand it into the blow moulding cavity it is possible that another gas such as nitrogen or even a liquid could be used. In a further alternative, it would be possible to create a vacuum on the outside of the preform to draw it into the blow moulding cavity. Indeed a combination and blowing and drawing could be used.

The cycle times for the injection-blow moulding of an article in accordance with the invention could be reduced further by cooling the core pins 18, 118 and the movable mould members 22, 24, 26; 122, 124, 126 at the earliest possible moment in the moulding cycle. This may be before or during the stretching process where one is used. Cool air can also be used to expand the preform rather than hot and/or cool air or other fluid can be introduced into the container 32, 132 after it has been blow moulded to speed up the cooling process. The cool air or other fluid could be introduced through the core 18, 118.

Apparatus in accordance with the invention can be adapted in a variety of ways to produce a range of containers or other articles. For example, grooves may be provided in the surface of the core 18, 118 to forms ribs on the inner surface of the preform tube to enable the walls of the preform tube to be made thinner. Where the preform is stretched, the ribs will become thinner enabling them to be removed from the grooves in the core more easily.

For certain applications it is desirable to produce a laminated preform comprising layers of different materials. This arrangement is used to overcome problems caused, for example, by the permeability of the material used to form bottles or other containers. A particular example of this is bottles for carbonated drinks where the gas eventually diffuses through the material of the bottle. This problem has been resolved in the prior art by use of a barrier lining created by co-extruding two or more plastics as a tube. One end of the tube is cut in such a way as to join the two plastics to each other to make a preform in which one of the plastics forms a barrier lining to reduce permeability of the bottle.

The apparatus and method of the present invention can be modified to enable laminated preforms having two or more layers to be produced in a variety of ways.

FIGS. 6 and 7 show a third embodiment of an apparatus 210 in accordance with the invention, in which the apparatus is modified to produce a laminated container having two layers of plastic material. The apparatus 210 is similar to the apparatus 10 of the first embodiment except that it has an additional movable mould member 256 in the form of a third tube member which can be extended into the blow moulding cavity 214 through the opening 216 in the female mould tool so as to surround the core 218.

In a first stage in the moulding process, the third tube member 256 is extended into the blow mould cavity 214 around the core 218 to the position shown in FIG. 6. The central locking pin 222 and the first tube member 224 are also extended into the blow mould cavity until the first tube member 224 contacts the inner end of the additional mould member 256. In this position, the central locking pin 22 and the first tube member 224 define a base region of a first injection moulding cavity 228 surrounding the core 218. A first material can then be injected into the first injection moulding cavity 228 to form a first layer or tube 258 of the preform. As with the first embodiment, the central locking pin 222 may initially be extended so as to engage with the core 218 during the early stages of injection and is withdrawn in line with the first tube member 224 at the last moment.

Once the first material has been injected, the central locking pin 222 and the first tube member 224 are withdrawn to the position shown in FIG. 6 in which they are spaced from the base of the first layer. At this stage, or previously, the second tube member 226 is extended to the position shown in FIG. 6 so as to define in combination with the central locking pin 222 and the first tube member 224 a second injection moulding cavity 260 around the outside of the third tube member 256 and below the base of the first layer of material 258. A second material can now be injected into the second injection moulding cavity to form a second layer or tube 262 of the preform.

Once the second layer of material 262 is sufficiently stable, the third tube member 256 is withdrawn through the opening 216 and the first and second tube members 224, 226, together with the central locking pin 222 are withdrawn to form the base region of the blow moulding cavity 214. Air is then injected through the core so that both layers of material are expanded into the blow moulding cavity 214. The core 218 is then withdrawn, as shown in FIG. 7, and the female mould tool 210 is split to enable the container to be ejected. If required, the core 218 can be advanced into the blow moulding cavity to stretch the preform either prior to or during the introduction of air to blow mould the container.

In order to reduce cycle times, injection of the first and second layers 258, 262 can be overlapped by appropriate control of the moving mould members and injection apparatus.

The apparatus 210 of second embodiment produces a preform having a gap 263 between the side wall regions of the first and second layers 258, 262 whilst the bases of the two layers touch. This offers several possibilities. If the materials are such that they do not stick to one another, a gap can be created between the bases by expanding them to different positions. This gap can then be left or filled with a further plastics or an adhesive. Alternatively, a further material or an adhesive can in injected into the gap between the side walls whilst at the same time lifting the core 218 to enable the third material or adhesive to force its way between the bases of the two layers. In yet a further alternative, a further plastics material or adhesive can simply be injected into the gap between the side walls. The filler between the layers could be an epoxy resin or foam or an equivalent.

The apparatus 210 of the second embodiment can be configured so that the third tube member 256 is withdrawn before the second layer of material 262 is injected so that the second layer is moulded directly on top of the first layer 258 without a gap.

The laminated preform may be stretched prior to the blow moulding phase in a manner similar to that described above in relation to the previous embodiments.

In any of the embodiments described herein, some air may be injected between the core 18, 118, 218 and the inner surface of the preform to ease the preform off the core pin but without expanding the preform. Similarly air may be injected between the outer surface of the preform and the outer tube member to prevent them sticking together. Indeed air may be injected between the preform and any surface of the mould that contacts the preform to prevent the material of the preform from sticking to the mould surface. This may be particularly useful when moulding material like PET where cycle times can be increased because of the tendency for the material to cling to the metallic parts of the mould until a certain temperature has been reached.

FIGS. 8A, 8B and 9 illustrate a further embodiment 310 of a moulding apparatus in accordance with the invention and which is configured to produce a container having a second layer of material injection moulded directly on top of a first layer. In this embodiment of the apparatus 310, a third tube member 364 is provided about the second tube member 326 so as to extend into the blow mould cavity from the base region 314A.

FIG. 8A shows the apparatus 310 after a first layer of material 358 has been injected into a first injection moulding cavity 328. To form the first layer of the preform, the second tube member 326 is extended to a position in which it projects into the opening 316 in the female mould tool around the core 318. The central locking pin 322 and the first tube member 324 are extended to a position just below the distal end of the core 318 to form a base of a first injection moulding cavity. A first material can then be injected into the first injection moulding cavity to form the first layer or tube 358 of material. As with the previous embodiments, the central locking pin may be advanced to engage with the core to hold it steady during the initial stages of injection before being withdrawn to enable the base to be formed. A guide member 363 is shown in FIG. 8A surrounding the core 318 to form an upper end of the first injection moulding cavity 328 which extends beyond the cavity in the female mould tool.

Once the first layer 358 of material is sufficiently stable, the central locking pin 322, and the first and second tube members 324, 326 are withdrawn to the positions shown in FIG. 8B to form a base of a second injection moulding cavity 366 for the second layer 362 of material. The third tube member 364, which had already been advanced into the blow moulding cavity to the position shown in FIGS. 8A and 8B, defines the outer side walls of the second injection moulding cavity surrounding the first layer 358 of material. The second material is injected into the second injection moulding cavity to form the second layer or tube 362. When the second layer 362 is stable, all the movable mould members 322, 324, 326, 364 are withdrawn to the positions shown in FIG. 9, in which they defined part of a base region of the blow mould cavity 314. Air can then be blown through the core 318 to expand both layers of the preform to produce the container 332, as shown in FIG. 9. If required, the preform can be stretched by the core 318 either before or whilst air is being blown. Again, the cycle time can be reduced by overlapping the injection of the first and second materials with appropriate control of the movable mould members and the core.

In order to prevent uneven moulding of the second layer due to movement of the core, the second tube member 326 may be withdrawn to the position shown in FIG. 8B as the second material is being injected. Alternatively, or in addition, the central locking pin 322 and the first tube member 324 may be held in contact with the base of the first layer 358 of material until the side walls of the second injection moulding cavity have been filled before being withdrawn to form the base of the second layer 362.

In addition to providing means for locking the central core 318 to hold it in position during the injection moulding phase, means may be proved to lock any one or more of the movable tubular mould members 324, 326, 364 to prevent them being deflected whilst material is being injected into the mould cavities they form. The locking means could take any suitable form and may comprise means to interlock two or more of the tubular mould members or it may comprise one or more additional locking members that can be extended into the blow mould cavity to engage with a tube member to hold it steady during the injection moulding phase. Typically, the locking member will engage the tubular mould member at or close to the free end of the tube member which projects into the blow mould cavity. The arrangement for locking one or more of the movable mould members is particularly beneficial where the apparatus is adapted for producing a laminated preform but can be equally applied to any of the embodiments described herein.

As with the previous embodiments, the apparatus can be adapted to produce any desired shape or contour at the base of the article and may be arranged to provide one or more holes in the base of the container body and/or in any lining.

When moulding a preform having an outer layer 362 and an inner layer or lining 358 made of compatible materials the bases of the layers may stick together or they may form a common base for the two layers. If the materials are not compatible, one layer 358 may be produced first and allowed to harden sufficiently before the second layer 362 is moulded on top as described previously. However, as indicated above, it may be desirable to inject the second layer 362 over the first layer 358 before the first layer has been fully formed to reduce cycle times. As the material for the first layer is injected, the first layer will form from the top of the mould cavity down towards the base. Once an upper portion of the first layer has been formed, it is possible to begin retracting the second movable mould member and injecting the second material on top of the first material so that the second layer also forms from the top down but slightly behind the first layer. This enables the two layers to be formed in close succession and requires the base of the second layer to be produced very quickly after the base of the first layer. As the base of the first layer is being produced, the central locking pin 322 is initially in engagement with the core 318 and the first and second tube members 324, 326 are spaced from the core 318 by the thickness of the first base. As the base of the first layer nears completion, the locking pin 322 is withdrawn allowing the material of the first layer to fill the gap left by the pin. At this stage, the material of the first layer 358 is under very little pressure and the first and second tube members 324, 326 and the locking pin 322 can be lowered by an amount sufficient to create the base of the second layer. Since the material of the second layer 362 is at a higher pressure than that of the first layer, the material of the second layer will drive under the first layer creating the base of the second layer. Because the materials of the first and second layers are not compatible, they do not stick or co-mould. If necessary, the pressure in the material of the first layer 358 could be further reduced by retracting the core pin 318 slightly as the base of the second layer is formed.

It will be appreciated that there are numerous ways in which apparatus in accordance with the invention can be modified to produce preforms having multiple layers of material; including preforms have three, four, five, six or more layers as required. In one example, the core may be stepped so as to have a smaller diameter innermost or distal region and a larger diameter outermost or proximal region. The innermost, smaller diameter region is initially advanced into the moulding cavity and is received in a central opening in a tube member projecting from the base of the female mould tool. A second tube member surrounding the first can be extended from the base into the blow mould cavity around the outer, larger diameter region of the core to define an injection moulding cavity into which a first material can be injected to form an outer layer of the preform with the core. Once the first material has been injected, the core can then be raised to bring the smaller diameter region within the first layer so that a second material can be injected into the gap between the outer layer and the core to form an inner layer.

When producing laminated preforms, the layers of material may be selected so that they adhere to one another or a glue or adhesive (such as an epoxy resin, foam or the equivalent) could be injected between some or all of the layers to join them together. This increases the integrity of the component but has the disadvantage that the materials used in the various layers must be compatible. As a result, the materials selected may not be the best for fulfilling the functional requirements of the various layers. With the method and apparatus of the present invention, at least some of the multiple layers can be heated and expanded separately so that it is not essential that they adhere to or are glued to one another. For example, in certain applications it may be advantageous to have at least one layer, often the inner layer, which does not stick to the outer layer or layers. This means that the materials for the non-bonding layers can be selected for their optimum functional performance without having to ensure compatibility. In practice, almost any combination of polymeric materials can be used.

Regardless of whether it is bonded to the outer layer or layers or not, the inner lining layer 358 may extend all the way to the opening of the container and onto its rim. Thus, as shown in FIGS. 8A to 9, the inner layer could be made to extend out beyond the opening of the container so that it can be folded down over the outer surface of the neck region. This may be useful where the lining is a soft material as it can act as a seal between the opening and a closure member.

When blow moulding a container in which some layers are expanded separately, it may be advantageous to heat the various layers to different temperatures before they are expanded. This could be achieved by incorporating into the moulding apparatus dividing walls, which act as a thermal shield between some or all of the layers.

The ability to blow mould containers having one or more inner layers that do not stick makes it possible to produce differently sized and shaped containers by introducing air both into the inside of the innermost layer and/or in between some or all of the layers.

FIG. 10 illustrates an apparatus 410 in accordance with the invention which has been adapted to produce a container from a preform having three layers of material, an outer layer 468, an intermediate layer 462, and an inner layer 458. The movable mould members required to produce the three layers are not shown in detail but are indicated generally as 469. However, it will be readily apparent to those skilled in the art that the embodiment shown in FIGS. 8 & 9 can be adapted to produce a third preform layer by the addition of a further tube member surrounding the third tube member 364.

During the blow moulding phase, air has been introduced into the space 459 between the inner layer 458 and the intermediate layer 462 to expand the intermediate and outer layers 462, 468 into contact with the blow moulding cavity in the usual manner. Air has also been introduced inside the inner layer 458 but the pressure difference between the air in the inner layer 458 and that in the space between the intermediate and outer layers 462, 468 has been controlled so that the inner layer 458 only partially expands. In the arrangement as shown in FIG. 10, a gap 463 is provided between the intermediate and outer layers 462, 468 which may be filled or may be left empty.

There are numerous ways in which the partial expansion of an inner layer 458 can be controlled. For example, air may be introduced between the intermediate layer 462 and the inner layer 458 to expand the intermediate and outer layers 462, 468 before introducing air inside the inner layer 458 to inflate the inner layer to the size required. Various alternative means of achieving this effect will be readily apparent to those skilled in the art.

The inner layer or tube 458 may be produced from a material that sets to form a rigid inner chamber or from a flexible material that forms a bag like structure. This technique can be adapted to produce a number of separate chambers in the container by partially expanding two or more layers of the preform.

The arrangements discussed above can be used to produce a variety of useful containers. For example, if the inner tube 458 is manufactured from a flexible material this results in effect in a bag within a container body defined by the outer layers 462, 468, which may be rigid. This arrangement can be used to beneficial effect by introducing a product into the inner bag. The product may be a liquor or foam or a thick liquid or even a particulate product and a valve may be provided to control release of the product. If the inner bag is resiliently expandable, a product can be introduced into the inner tube 458 under pressure so as to expand the inner tube within the body of the container and a valve can be provided to control release of the product. When the valve is opened, the inner tube 458 will contract and dispense the product in the manner of a pump. To assist in dispensing of the product, an input into the chamber 459 between the outer body of the container and the inner tube or bag 458 can be built into the moulding so that a pressurised gas can be introduced into the chamber 459 between the inner bag and the body. This results in a pressurised container similar to an aerosol canister. Alternatively, further stretchable resilient bag can be moulded about the inner bag into which a pressurised gas can be introduced. Some of the gas can be bled into the product as it is dispensed. Suitable holes or channels will be moulded into the top of the various linings or tubes to interact with the valve to enable the product and gas to exit in the required manner.

Alternatively, a second product could be introduced into the chamber 459 formed between the inner container or bag 458 and the outer body. The second product can be arranged to mix with the product in the bag when it is dispensed, or separate openings into the bag and outer chamber may be provided. Where separate openings are provided, the two products may be the same and this arrangement can be used to enable each chamber to be sealed and opened separately. This might be useful where the product has a limited life once opened. A further alternative is to place a food product, such as milk or lemonade, in the inner bag with a one-way valve that lets the product out of the bag but no air in. Means can be provided to allow air to enter the chamber between the bag and the body of the container so that as the product is used up, the bag will collapse keeping the air from the product and preventing or at least slowing down the deterioration of the product. In the case of carbonated or fizzy drinks, these would retain their fizzyness for far longer than in conventional bottles. More than one non-stick layer can be provided to enable a container having several different chambers to be produced.

In a further alternative, it would be possible to produce an article having inner and outer containers which are made of the same or a similar material. Where the outer container is rigid, the inner container can be made flexible by making it thinner and/or by varying its shape. This would produce an arrangement that falls in between a rigid inner container and a resilient bag and could have a number of useful applications. For example, this construction could be used for storing and dispensing carbonated drinks, with the product being stored in the inner container and having a one way valve at the outlet to prevent air entering the inner container when the contents are emptied. As the contents are dispensed, the inner container would collapse, though not to the same degree as a flexible inner bag. However, the inner container can be made sufficiently flexible that at least 80% of the contents can be dispensed without the need to admit air into the inner container, which would be sufficient for most products. Because air is not admitted to the inner container, the contents of the inner container will have a longer useful life before going flat or becoming otherwise contaminated. An air release valve would usually be provided between the inner and outer containers, though to improve the shelf life of the product a vacuum or a slight increased pressure could be produced in the space between the inner and outer containers, at least until the inner container is opened. Because of the extra layer of material provided by the inner container, the outer container can be made thinner than a conventional rigid container yet there will be a reduced loss of gas from the product through the container and a reduced amount of air entering the product through the plastic. Use of this arrangement is not restricted to carbonated drinks but can be applied to any product whose useful life can be increased by keeping air out. For example, this arrangement could be used with squeeze bottles, foamers and pumps where the product is kept in the inner container.

Whether the inner layer forms a flexible bag or a semi-flexible container, making the nominal or resting volume of the inner container as small as possible ensures that the maximum amount of the product can be dispensed. Since the preform for the inner container must be formed about the inner core 418 it will always be moulded initially with a minimum volume determined by the size of the core. However, rather than expanding the inner layer as in a normal blow moulding process, the inner layer can be shrunk whilst still soft to reduce its nominal or resting volume. This can be achieved in a number of ways. For example, once the inner layer has been injected but whilst it is still soft, the core can be retracted and a higher air pressure exerted on the outside of the inner layer than inside so that the inner layer collapses in on itself to reduce its internal volume. The inner layer is then allowed to set in the collapsed state and this becomes its resting volume, to which it will tend to return when expanded. The higher air pressure on the outside of the inner layer can be created by injecting pressurised air between the inner layer and an outer layer and/or by creating a partial vacuum inside the inner layer.

Where the inner layer is an elastically resilient bag, the resting volume can be reduced to virtually zero. Thus, when a product is introduced into the bag, the bag expands but will try to return to its resting volume and so pressurising the product. Because the resting volume is very small, virtually all the product can be dispensed, even without introducing a pressurised gas between the bag and the outer body. The principal can also work where the inner layer is made of the same material as the outer layers of the container and is not resiliently flexible. Thus in a bottle having a body moulded from PET or polythene, an inner tube layer can be moulded from the same material than the outer body layer(s) but made thinner to give it some flexibility. The outer layer or layers are blown as normal to produce the outer body of the container but the inner layer is collapsed as described above so that it occupies a reduced volume, which may be about one third of its original injection moulded volume. When a product, such as carbonated drink or milk, is introduced into the inner container it will expand, though the product will not be pressurised as the material of the inner container is not resilient. Nevertheless, the inner container will have a tendency to want to return to its resting volume and will generate sufficient force that when the bottle is tipped the product is dispensed without having to draw air into the inner container. Thus the majority of the product can be dispensed without air being drawn into the inner container, which will increase the life and quality of a large number of liquid products, such as carbonated drinks or milk. A one way valve could be provided at the outlet to prevent air being drawn in to the inner container and the outer body may be flexible enough that it can be squeezed to pressurise the air between the inner container and outer body which in turn would pressurise the inner container to help drive the product out. Alternatively, or in addition, a pressurised gas, such as air, could be introduced between the inner container layer and the outer body. This type of container arrangement could also be useful in dispensing more viscose products such as toothpaste or a cream.

There is an increasing requirement for recycling materials. However, use of recycled maters in containers for products that are intended for human consumption is limited. By producing containers having an inner lining, the use of recycled materials can be increased as the inner lining layer can be made from virgin material whilst the outer layers are made from recycled materials or a combination of recycled and virgin material. This would be particularly beneficial in allowing the use of recycled materials in the production of containers for foodstuffs and drinks.

In addition to using an inner layer of material to form a container within a container, an inner layer of material can be used to form an integral dip tube within a container, which extends toward the base of the container. This would be particularly applicable where the container is to form part of a pump action or aerosol type dispenser. The inner end of the dip tube will be open to form an inlet that may be located within a recess in the base of the container into which the fluid in the container drains as the contents are emptied. This will ensure that the maximum amount of the product can be dispensed. Alternatively a walled or dammed area may be created around the inner end of the dip tube to hold the fluid.

An integral dip tube could be formed through the centre of the container using a preform having an inner layer, which does not adhere to and is not bonded to the outer layer or layers. The inner layer is formed with no base or with a hole in the base to provide the inlet. When the preform is blown, both the outer layer or layers and the inner layer forming the dip tube are stretched but only the outer layer or layers of the preform are blown or expanded so that the inner layer does not increase in diameter.

An integral dip tube may also be formed along an outer wall of the container as shown schematically in FIGS. 14A and 14B. The container, 832 has an outer body 880 which may comprise one or more layers of material. An integral dip tube 882 is formed along the side wall of the body extending from the neck region 884 of the container to the base 886. The inner end of the dip tube has an opening 888 and is located in a recess 890 in the base. The preform for the container is made in the same general manner as described above with a larger tube for the body of the container and smaller tube formed on one side of the larger tube for the dip tube. The core 18 of the moulding apparatus has a projection on the end, which corresponds to the gap at the base end of dip tube to form the opening 888. The inside of the body preform tube and the dip tube preform tube are stretched but only the outer layer or layers are blown to expand them into the blow moulding cavity. Thus whilst the dip tube preform is stretched it is not expanded but is moved towards one side of the body of the bottle where it bonds to the inner wall of the body. The dip tube formed may be of the type disclosed in International patent WO2004/022451 which is configured to enable the dispenser to be used even when tipped upside down.

An alternative method of providing two or more chambers in a container produced using the apparatus and method of the invention is to make one more internal dividing walls across the interior of the container. Dividing walls can be produced by splitting the core into two or more parts with a gap between each part. For example, FIG. 11 illustrates a container divided into two semi-circular chambers 570, 572 by means of a central a dividing wall 574. This arrangement is achieved by dividing the core into two halves with a gap in between. When the material is injected in the injection moulding cavity to make the preform, it will fill the gap between the core halves (as well as the cavity surrounding the core) to form a dividing wall. When the preform is expanded, air can be introduced through each of the core halves to expand both sides evenly to create a container with two even semi-circular compartments. When the material is being injected, the central locking pin can be arranged to engage both of the core halves initially holding them in place during the first part of the injection moulding process to maintain an even wall thickness.

The core can be divided into any number of parts to produce the number of compartments required. Furthermore, the preform and the subsequent container may be formed from two or more layers of material as discussed above. FIG. 12 illustrates a container formed from two layers of material which form an inner tube 576 and an outer tube 577 and in which the inner tube is divided into two chambers 570, 572 by a wall 574. FIG. 13 illustrates a container also having an inner tube 576 and an outer tube 577, with the inner tube divided into four compartments 578-582 by means of two walls 574, 575. This latter arrangement would be produced using a core divided into quarters with a gap between each quarter. It will be appreciated that a container with dividing walls in this manner may have more than one inner tuber or lining if required.

The dividing walls need not be planar as shown in FIGS. 11 to 13 but could be shaped so as to prevent the wall from bowing over to one side. Thus the dividing wall or walls may be corrugated, concertinaed or shaped like a sine wave across the container. This may be necessary particularly with bottles having a large dividing wall, which requires greater structural rigidity. Shaping the walls in this way will give them more strength and make any distortion less obvious. FIG. 15 is a cross sectional view through a further embodiment of a container 932 having a corrugated dividing wall 974. The shape of the dividing wall is determined by the profile of the mating faces of the core halves.

Any of the above discussed embodiments could be stretch blow moulded, by moving the core to stretch the preform at the appropriate moment in the process.

The containers produced using the apparatus and method of the invention need not be circular in cross section but can be made in any desired shape. Equally, the preform need not be tubular and the wall thickness of the preform can vary around it and/or along its length. In addition, where the container is laminated, the outer layers of the container need not be rigid but could be made of a flexible material so that the resultant container will comprise a flexible, or possibly even rigid, inner tube inside a flexible outer tube. A potential use for this construction would be to have two different products, one in the inner tube and one in a chamber between the inner and outer tubes. The container can be arranged so that the products are mixed as they are dispensed. Alternatively, air could be provided in one of the tubes to mix with a liquid product in the other to create foam as it is dispensed.

Products are being put into containers under increasingly higher pressures. To cope with the higher pressures, the containers are usually bottles having increased wall thickness. With the method and apparatus of the present invention, containers capable of withstanding higher pressures can be manufactured more easily than with conventional blow moulding techniques. Increasing the thickness of the walls of the container can be achieved using the method and apparatus of the present invention by making the initial preform thicker and/or by making containers with multiple layers. Where the preform and container have multiple layers, it is also possible to incorporate non-plastic filler between the layers.

Containers manufactured using the apparatus and methods of the invention may produce with integral lids or other closure members, which are connected to the main body of the container by a flexible hinge or lanyard. FIG. 16 illustrates schematically a container 1032 having an integral top 1092 attached to it by a lanyard 1094. In this embodiment, the top and the container have a screw thread that requires only a 45-degree twist to fully close. The lanyard is sufficiently flexible to allow the required degree of movement. Furthermore, whilst the containers shown in the embodiments described herein have all included a screw thread on the neck region for co-operation with a lid or other closure member; other neck formations can be provided. For example, the neck formations may be adapted to receive a snap fitting lid or pouring nozzle. The method and apparatus of the invention can be used to produce a wide variety of vessels having integral lids or other closure members. In particular, any of the embodiments described herein can be moulded with an integral closure member including any of the laminated containers and the containers with inner dividing walls as described with reference to FIGS. 11 to 13 and 15.

Other components may also be moulded integrally with a body of a container using apparatus and methods in accordance with the present invention. For example, where a container is to form part of a dispenser, parts of a pump or trigger or valve might be moulded integrally at the top of the container. If the container has a lining of a flexible material, this material could be used to form parts moulded at the top of the container. Bi-injection moulding techniques may be used as appropriate.

The problem of injection moulding thin walled articles from plastics has been discussed above. Also discussed above is the tendency for the core to move to one side under the pressure of the injected plastic, especially if the preform is long and narrow. Both of these problems can be addressed by operating the various embodiments described above in a modified way. Accordingly, rather than moving the core and the movable mould members into a position in which the preform injection cavity is fully defined and injecting the material, the plastic material could be injected as the core is introduced into the female mould tool. The movable mould members that define a base region of the preform mould cavity would usually be spaced from the distal end of the core and would move with the core as it is extended.

This alternative method of operation will now be described with reference to the apparatus 10 shown in FIGS. 1 to 3 as an example. Those skilled in the art will readily appreciate that the method can be adapted for use with any of the other embodiments described. With the mould tool 12 assembled, the second tube member 26 is extended into the position shown in FIG. 1 but the core is retained in a raised position in which it has not yet entered the larger blow mould cavity 14 or is only slightly protruding into the cavity. The central locking pin 22 and the first tube member 24 are extended into the cavity 14 to a position in which they are spaced from the end of the core 18 by an amount equal to the desired the thickness of the base region of the preform or just slightly more. The material is injected into the space around the core 18 as the core is extended further into the cavity 14, with the central locking pin 22 and the first tube member 24 following the movement of the core 18 to maintain their spaced relationship with the core. This continues until the core 18, the central locking pin 22 and the first tube member 24 reach the position shown in FIG. 1 and the preform 33 has been moulded.

The above method helps the plastic flow into the volume between the core and the movable mould members such that the gap between the core 18 and the second tube member 26 can be made smaller to produce a preform with thinner walls. The arrangement is also more stable such that the chances of the core being moved to one side are reduced. However, the central locking pin 22 could be advanced so as to contact the core 18 as it is extended into the cavity, with the pin being retracted in line with the first tube member 24 towards the end of the injection moulding process. Once the central locking pin 22 has been retracted, the core 18 and/or the central locking pin 22 and the first tube member 24 can be moved to compress the material in the base region to ensure that the hole occupied by the central locking pin 22 is filled and to thin out the base. Once the injection moulding phase is completed, the movable mould members 22, 24, 26 are retracted as shown in FIGS. 2 and 3, to enable the preform to be blow moulded as previously described. If desired, the preform may also be stretched by advancing the core. The final shot weight or amount of material to be injected would usually be calculated in advance so that at the end of the cycle some material is forced back up the gap between the core and the movable mould members, which is rarely the same all the way along.

A further modification, which can be used in conjunction with any of the methods of operation described herein, is to form a recess within the tool in which some of the plastic material can be retained during the early stages of injection moulding and to use a movable pin or the like to close the recess and push the material into the injection moulding cavity towards the end of the injection moulding process. This is particularly useful when producing thin walled preforms or when using the modified method of operation described above, where it can be difficult to get the plastic down to form the base of the preform or where there may be nowhere for the excess material to go. The recess could be formed anywhere in the mould tool but will usually be near to the base region of the preform.

FIG. 17 illustrates how the locking pin arrangement shown in FIG. 1 can be adapted to provide a recess in a base region of the tool. In the modified apparatus 1110, the inner end of the first tuber member 1124 is profiled so as to be capable of engaging with a correspondingly profiled inner end of the core 1118 to prevent or reduce lateral movement of the core. This enables the first tube member 1124 to be advanced into contact with the core 1118, as shown in FIG. 17, to act as a locking arrangement to hold the core in a central position during the majority of the injection phase. The central pin 1122 in this embodiment does not act as a locking pin but can be retracted relative to the first tube member 1124 as shown in FIG. 18 to form a recess 1198 for holding an amount of the plastics material 1116. In order to fill the recess 1198 with material, injection moulding is initiated with the first tube member 1124 spaced from the core 1118 and the central pin 1122 retracted until the recess is filled. The first tube member 1124 is then advanced into contact with the core 1118 and the injection moulding process continues to form the side wall of the preform. Alternatively, additional feed channels can be provided to inject material directly into the recess. Towards the end of the injection moulding phase, the first tube member 1124 is retracted away from the core 1118 so that an injection moulding cavity for the base of the preform is produced and the central pin 1122 is advanced to close the recess 1198 and push the material 1116 out into the injection moulding cavity to form the base. The concept of providing a closable recess in an injection moulding tool in this way is not limited to use in the apparatus and method of the present invention but can be used in conjunction with any injection moulding apparatus and methods. Accordingly, patent protection for this concept may be sought independently of the presently claimed invention.

The apparatus and method of the invention may also be adapted for use with injection-compression moulding techniques in which a predetermined amount of material is injected into the mould tool before it is brought together. For a detailed description of injection-compression moulding methods and apparatus the reader should refer to International patent application WO 02/058909 A1 to Coral-Tech Limited, the contents of which are hereby incorporated by reference. A method of using injection-compression moulding with apparatus in accordance with the invention will now be briefly described with reference to the embodiment shown in FIGS. 1 and 2, by way of example. With the movable mould members 22, 24, 26 and the core 18 advanced into the mould cavity as shown in FIG. 1, a measured amount of material is injected into the cavity between the core 18 and the movable mould members 22, 24, 26 whilst applying a light closing pressure to the core 18 and/or the movable mould members 22, 24 such that the material can cause the cavity between the core 18 and the movable mould members 22, 24 to expand. A high closing pressure can them be applied to the core 18 and/or the movable mould members 22, 24 to fully form the injection moulding cavity and compress the material so that it spreads throughout the cavity between the core 18 and the other movable mould members 22, 24, 26. Those skilled in the art will appreciate that the apparatus in accordance with the invention could be adapted and operated in various ways to make use of injection-compression moulding techniques.

The embodiments described herein comprise means for locking together the core and at least one of the movable mould members, which form a base of the preform to reduce their movement during the injection moulding phase. However, it should be noted that any of the movable parts of the mould apparatus might be locked, either with another movable part or with a stationary part of the apparatus, to prevent or reduce movement in a similar manner.

One example of a product, which might be manufactured using the method and apparatus of the present invention, is a tube of the type used for containing and dispensing toothpaste or the like. Such tubes have a flexible body with a flatted end enabling the entire product to be squeezed. Presently, tubes of this type are manufactured by extruding a plastics tube portion, usually with several layers of different polymeric materials with adhesive in between them. A shoulder having an outlet spout with an external thread and a separate threaded cap with a hinged lid are then injection moulded from harder materials. The shoulder is welded onto one end of the tube portion and the top screwed onto the shoulder with the lid closed. Product is then introduced into the tube through the other end of the tube portion which is subsequently squashed and heat sealed. The known methods of manufacturing such tubes are very expensive and there are often problems with the welding not being complete and leak proof.

Using the methods and apparatus of the present invention, a tubular preform portion can be injection moulded with an integral shoulder portion in one injection moulding process. The integral shoulder may have an integral hinged closure lid or a threaded top could be made separately as with conventional tube. The preform may be produced with multiple lining layers of different materials if needed using the techniques described above and adhesive can be introduced between the layers if required. The preform can then be blown to make the tubular portion which is shaped to taper at the bottom in a manner similar to that of conventional tubes. The base of the tube is then cut off (usually in the moulding tool) and the whole tube ejected from the tool mould. Once the tube has been ejected, the cap or top is put on and the tube filled through the cut off end, which is then squashed, and heat-sealed in the usual way.

Cutting the base off the tube allows conventional filling apparatus to be used. However, it would also be possible to leave the base on the tube and to fill the tube though the shoulder. One possible method would be to form a larger opening in the shoulder for filling. The opening can be closed by a closure member or top which is either a frictional fit in the opening or which can be welded to the shoulder. The top may include a smaller outlet opening through which the product is expelled in use and a hinged closure for the outlet opening. The top may be moulded integrally with the shoulder and attached by a flexible hinge or may be a separate component.

Producing a tube using the methods and apparatus of the invention reduces the number of manufacturing steps and cycle times thus saving costs. In addition, the tube can be shaped for added effect. This might include the provision of indents for the finger and thumb, for example. Use of the methods and apparatus in accordance with invention also allows tubes to be manufactured using materials that are difficult to use with conventional methods, such as PET.

In any of the methods and apparatus in accordance with the invention, and in particular in any of the embodiments described herein, any suitable additives or fillers may be incorporated into the polymeric moulding materials. For example, blowing or foaming agents may be incorporated into the materials in manners that will be well known to those skilled in the art. Indeed the method and apparatus of the present invention is particularly suited to the production of foamed blow moulded containers by the addition of a foaming agent to the plastics material.

The use of foaming agents in the manufacture of moulded articles is well known. For example WO97/03800 to Patrick Clark et al discloses a moulded foam article, whilst WO99/32544 to Trexel, Inc describes a microcellular foam extrusion/blow moulding process. The reader should refer to these documents for further information regarding the use of foaming agents when moulding polymeric materials and their contents are hereby incorporated by reference.

Typically, the foaming agent is added to the polymeric material when it is in pellet form or at the molten stage and they are co-injected into the mould tool. The material doesn't foam until the pressure on the material is reduced and/or the temperature drops and this usually happens when the product is ejected from the mould tool. However, a problem with using foaming agents when producing blow moulded bottles or containers using conventional blow moulding methods is that material will foam when the preform is removed from the injection moulding tool or is extruded. When the preform is subsequently blown, the pressures used in the blow moulding process are sufficient to crush the foamed structure. However, when using the methods and apparatus in accordance with the present invention, in which the preform is injection moulded and then blown within the same mould cavity, the material in the preform can be prevented from foaming before the product is blown by keeping it hot and under pressure until the blow moulding phase is completed. The product can then be ejected whilst still warm so that the foam forms in the material of the blown product.

Using foaming agents in this manner has the advantage that less polymeric material is used in the product, which reduces the material costs. The cycle time is also shortened due to the reduced wall thickness in the moulded product prior to the foam forming and the fact that the product is ejected whilst still warm. A container or bottle manufactured with foamed material is very strong, light and rigid and has improved heat insulation which may be useful for holding hold hot or cold liquids or the like.

It is becoming common practice to stack moulding machines vertically to make the most efficient use of available floor space. Apparatus in accordance with the invention, including any of the embodiments described herein, can be configured so that it is stackable in this manner.

The term “preform” as used herein should be understood to encompass any injection or extruded moulded article at least a part of which is adapted to be subsequently expanded by applying a pressure differential across said part. Furthermore, whilst the preferred embodiments of the apparatus have been described as having an injection moulding cavity for the preform, it should be understood that the invention can be equally applied to extrusion moulded preforms and thus reference to an injection moulding or mould cavity should be understood as encompassing an extrusion moulding cavity and references to injection moulding should be understood as encompassing extrusion moulding except where the context requires otherwise.

It is expected that apparatus in accordance with the invention will be used with, or will be a modification of, conventional injection moulding machines.

Any of the various aspects of the apparatus, methods and moulded articles and their preforms as described herein may be claimed independently of the invention as set out in the claims or the statements of invention and each other. In particular, whilst it is an advantageous aspect of the invention that the preform is moulded inside the blow mould cavity, various of the novel preform arrangements described herein can be moulded outside of a blow mould cavity in accordance with the known single-stage or two-stage techniques. Accordingly, patent protection may be sought for the preforms and for the apparatus and methods of their production independently of the concept of moulding the preforms inside a blow mould cavity. In particular, independent patent protection may be sought for the various laminated preforms and for the apparatus and methods of their manufacture. The apparatus for producing such preforms may comprise any of the features described in the preferred embodiments but excluding the mould tool which defines the blow mould cavity. Similarly the methods of producing the preforms may comprise any of the methods described in the preferred embodiments up to the stage at which the injection moulding steps have been completed.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1. Moulding apparatus comprising a mould defining a blow mould cavity and a core which projects into the blow mould cavity, the mould including at least one mould member moveable between an extended position in which it defines together with the projecting core at least part of a preform moulding cavity for moulding a preform and a retracted position whereby a preform produced in the preform moulding cavity can be expanded into the blow mould cavity, the moulding apparatus further comprising a locking member adapted to engage the core so as to resist lateral movement of the core.

2-41. (canceled)

42. A method of moulding an article using apparatus comprising a mould defining a blow mould cavity and a core which may project into the blow mould cavity, the mould including at least one mould member moveable between an extended position in which it defines together with the core at least part of a preform moulding cavity and a retracted position whereby a preform produced in the preform moulding cavity can be expanded into the blow mould cavity, the moulding apparatus further comprising a locking member adapted to engage the core so as to resist lateral movement of the core, the method comprising:
projecting the core into the blow moulding cavity;
moving the at least one moveable mold member to an extended position to define said at least a part of a preform moulding cavity about the core;
introducing a plastics material into the preform moulding cavity to form at least part of a preform;
moving the at least one moveable mould member to a retracted position and, once a preform has been fully formed, creating a pressure differential across the preform to expand at least part of the preform into the blow mould cavity; in which the method further comprises:
engaging the locking member and the core and holding them in engagement during an initial phase of introducing plastics material into the preform moulding cavity;
subsequently disengaging the locking means and the core whilst continuing to introduce material into the preform moulding cavity until it is substantially full.

43-92. (canceled)

93. A blow moulded container comprising an outer body, a first flexible container within the body adapted to receive a product to be dispensed, a second flexible and resilient container surrounding the first flexible container within the body, said second container being adapted to receive a fluid under pressure and having an initial volume less than the volume of the pressurised fluid to be introduced, and a valve means to control release of the product from the first flexible container.

94. A preform for a container as claimed in claim 93, the preform comprising one or more outer layers which are expandable to form the body of the container and at least two inner layers formed of a relatively flexible material and which are not bonded to the outer layers or to each other, at least over a significant portion of their surface area.

95. A blow moulded container comprising an outer body and an inner container located within the body and which is adapted to receive a product to be dispensed, the inner container being flexible relative to the outer body and the container further comprising a valve means which allows the product to be discharged from the inner container but which prevents atmospheric air from entering the inner container, the body and the inner container being moulded integrally from plastics materials.

96. (canceled)

97. A preform for a container as claimed in claim 95, said preform comprising one or more outer layers which are expandable to form the body of the container and at least one inner layer which is formed of a material which is relatively flexible when compared with that of the one or more outer layers and which is not bonded to the one or more outer layers at least over a significant portion of its outer surface area.

98. (canceled)

99. A blow moulded container which defines an inner volume and at least one internal wall which divides the inner volume into two or more separate chambers.

100-101. (canceled)

102. A preform for a container as claimed in claim 99, in which the preform comprises a generally tubular portion and at least one wall member which extends across the interior of the tubular portion to divide it into at least two separate chambers.

103. A blow moulded container having a hollow body and a smaller diameter tubular member affixed to an inner surface of the body.

104. A blow moulded container as claimed in 103, in which the smaller diameter tubular member comprises a dip tube.

105. A preform for a blow moulded container as claimed in claims 103 or 104.

106-109. (canceled)

110. Moulding apparatus comprising a mould defining a blow mould cavity and a core which projects into the blow mould cavity, the apparatus further comprising a plurality of movable mould members each of which is movable into the blow moulding cavity to define together with the core or with another of the movable mould members at least part of an injection moulding cavity for a preform, the movable mould members and the core being movable in sequence such that, in use, a preform having multiple layers of different materials can be injection moulded; characterised in that the apparatus comprises a locking member configured to engage the core so as to resist lateral movement of the core during at least part of the preform moulding operation.

111. Moulding apparatus as claimed in claim 110, in which the locking member comprises one of the movable mould members which is configured to engage a core pin in use so as to hold the core pin steady during at least part of a preform moulding operation.

112. Moulding apparatus as claimed in claim 110, in which the movable mould members are movable in sequence to define a mould cavity for each layer of the preform and the apparatus further comprises means for introducing material into each of said mould cavities.

113. Moulding apparatus as claimed in claim 112, in which the movable mould members and the core are adapted to be arranged in one configuration in which they define a preform mould cavity for moulding an inner layer of the preform, and a further configuration in which they define a preform moulding cavity for a moulding a further layer of the preform externally of the first.

114. Moulding apparatus as claimed in claim 113, in which the movable mould members and the core are adapted to be arranged in one or more further configurations, in each of which they define a mould cavity for moulding a respective further layer of the preform.

115. Moulding apparatus as claimed in claim 110, in which the apparatus comprises a plurality of generally tubular movable mould members, each tubular mould member having a different inner diameter and each being movable to an extended position in which it surrounds the core in spaced relation thereto to define an outer surface of a side wall region of a preform moulding cavity.

116. Moulding apparatus as claimed in claim 115, in which at least some of the tubular mould members are mounted concentrically and can be configured to define a base region of the blow mould cavity when retracted.

117. Moulding apparatus as claimed in claim 111, in which said one of the movable mould members is in the form of a locking pin which is movable to an extended position in which it engages a distal end of the core, at least one of the tubular mould members being arranged concentrically about the locking pin.

118. Moulding apparatus as claimed in claim 110, in which the apparatus comprises means to control the pressure differential across two layers of the preform so that, in use, only some of the layers of the preform are fully expanded into the blow moulding cavity.

119. Moulding apparatus as claimed in claim in claim 110, in which the core is movable within the blow mould cavity to stretch the preform.

120. Moulding apparatus as claimed in claim 110, the apparatus further comprising locking means for engaging at least one of the movable mould members whilst it is extended to define a preform moulding cavity to resist lateral movement of the member whilst material is introduced into the cavity.

121. Moulding apparatus as claimed in claim 110, in which the apparatus is configured to mould a lid or other closure member for the article integrally with the preform.

122. A method of moulding an article having a plurality of layers using apparatus comprising a mould defining a blow mould cavity and a core which projects into the blow mould cavity, the apparatus further comprising a plurality of movable mould members, each of which is movable to an extended position within the blow moulding cavity to define at least part of a moulding cavity for a layer of the preform, the method comprising:
moving the core and the movable mould members to a first configuration in which they define a first moulding cavity for a first layer of the preform;
introducing a first plastics material into the first preform mould cavity;
moving the core and the movable mould members to a second configuration in which they define a second moulding cavity for a second layer of the preform and introducing a second plastics material into the second preform moulding cavity to form a second layer of the preform;
retracting all the movable mould members;
creating a pressure differential across the preform to expand at least part of the preform into the blow mould cavity;
characterised in that the apparatus comprises a locking member adapted to engage the core so as to resist lateral movement of the core and the method comprises the step of engaging the locking member with the core during at least an initial part of the step of introducing the first plastics material into the first preform moulding cavity.

123. A method as claimed in claim 122, the method comprising disengaging the locking member from the core prior to completion of the step of introducing the first plastics material into the first preform moulding cavity.

124. A method as claimed in claim 122, in which the apparatus comprises a plurality of generally tubular mould members, each of which is movable to an extended position in which it surrounds the core in spaced relation thereto to define an outer surface of a side wall region of a preform moulding cavity for a layer of a preform, each of the tubular members having a different inner diameter from the other tubular members, the method comprising:
extending a first tubular member so that it surrounds the core to define with the core a side wall region of a first preform moulding cavity and introducing a first plastics material into the first moulding cavity to form a first layer of the preform;
extending a second tubular member with an inner diameter larger than that of the first tubular member into the blow mould cavity so that it surrounds the core to define a side wall region of a second preform moulding cavity and introducing a second plastics material into the second preform moulding cavity to form a second layer of the preform.

125. A method as claimed in claim 124, in which the inner diameter of the second tubular member is larger than an outer diameter of the first tubular member and the method comprises extending both the first and second tubular members so as to define the side wall portion of the second preform moulding cavity between an inner surface of the second tubular member and an outer surface of the first tubular member.

126. A method as claimed in claim 125, in which the method comprises retracting the first tubular member after the first layer has been formed so that the second layer of the preform is moulded directly on top of the first layer.

127. A method as claimed in claim 126, in which the method comprises retracting the first tubular member to a position in which it no longer surrounds the core before introducing the second plastics material into the second preform moulding cavity.

128. A method as claimed in claim 126, in which the method comprises introducing the second material into the second preform moulding cavity as the first tubular member is being retracted from its extended position, the second material filling the space left by the first tubular member between the second tubular member and the first layer of the preform as the first tubular member is retracted.

129. A method as claimed in claim 124, in which the method comprises retracting the first tubular member to a position in which an axial end face of the first tubular member is spaced outwardly from the distal end of the core to define part of an outer surface of a base region of the second preform moulding cavity.

130. A method as claimed in claim 124, in which the apparatus has at least one further tubular mould member and the method of operating the second tubular member is repeated for each further tubular member in sequence to form a respective further layer of the preform.

131. A method as claimed in claim 122, in which the apparatus comprises means to control a pressure differential across two layers of the preform, the method comprising:
controlling the pressure differential across two or more layers of a preform so as to expand one or more outer layers of the preform into the blow mould cavity whilst at least one inner layer remains unexpanded, partially expanded, or is contracted.

132. A method as claimed in claim 122, in which the apparatus comprises means for introducing a pressurised fluid into a space between two layers of the preform, the method comprising introducing a pressurised fluid into a space between two layers of the preform so as to expand the, or all of the, layers on the outside of the space into the blow moulding cavity.

133. A method as claimed in claim 132, in which the apparatus further comprises means for introducing a pressurised fluid into the inner volume of the preform and the method comprises balancing the pressure of the fluid in the space between the two layers and the pressure of the fluid in the inner volume to control the expansion of the, or each, layer inside of the space.

134. A method as claimed in claim 133, in which the relative pressures are controlled such that the, or each, inner layer is only partially expanded such that in the finished product, there is a gap between the inner layer or layers and the outer layer or layers.

135. A method as claimed in claim 122, in which the apparatus further comprises locking means for engaging at least one of the movable mould members whilst it is extended to define a preform moulding cavity to resist lateral movement of the member whilst material is introduced into the cavity, the method comprising:
extending the movable mould member to define at least part of a preform moulding cavity;
engaging the locking means and the movable mould member and introducing material into the preform moulding cavity;
subsequently disengaging the locking means and the movable mould member.
